(19) United States
(12) Patent Application Publication
(10) Pub. No.: US 2017/0314304 A1
(43) Pub. Date: Nov. 2, 2017

(54) PUSH AND/OR PULL HANDLE LOCKSETS

(71) Applicant: VANDER INDUSTRIES PTY. LTD., South Australia (AU)

(72) Inventor: THUAN NGUYEN, ADELAIDE (AU)

(21) Appl. No.: 15/528,092

(22) PCT Filed: Mar. 15, 2016
(86) PCT No.: PCT/AU2016/050180

§ 371 Date: May 18, 2017

(30) Foreign Application Priority Data
Mar. 16, 2015 (AU) 2015900938

(51) Int. Cl. E05C 1/14; E05B 63/00; E05B 13/00; E05B 1/00

(52) U.S. Cl. CPC E05C 1/14; E05B 63/006; E05B 1/0038; E05B 13/002; E05B 63/0056

(57) ABSTRACT

A push and/or pull handle lockset, comprising:
latch tongue (4) in first extended position, and operable to second retracted position; biasing means (6) urging the latch tongue (4) in first position; a linking means (12) to link the latch tongue to the actuator (16);
sliding shaft (20) extending through lockset roses (27, 36), and operable from first position to second operating position; a biasing means (26) urging the sliding shaft to first position; an engagement means (21) for sliding shaft (20) to engage with actuator (16); lock accommodations (22, 30) for locking means;
actuator (16) to translate movement of said sliding shaft to operate latch tongue (4) into second position;
locking means (45) interposed between the lockset roses in parallel alignment with sliding shaft (20) including latch arm (46) which is rotatable in and out of lock sockets (22, 30);
lockset unit operation is reversed by rotating the lockset unit one hundred and eighty degrees (180°) about it's horizontal lateral axis, changing the direction of actuator (16) or handle (43, 44) operation.

### TECHNICAL FIELD

The present invention relates to an improved door lockset with a novel locking mechanism.

### BACKGROUND ART

This invention relates to a conventional door lockset, which is commonly operated by applied rotational force upon a spindle traversing through the latch bolt assembly. This invention relates more particularly to the said traversing spindle and the change of operational movement from a conventional axial rotation to one which moves linearly along the longitudinal axis of the said spindle to retract a latch bolt assembly. The said spindle in the present invention is described as a square bar shaft, which is also commonly used in conventional door locksets. However, the preferred embodiment of said shaft in this invention is hereinafter described to slide backwards and forwards longitudinally within and partially through the lockset roses, as opposed to a conventional rotational or pivotal operation about it's longitudinal axis. Similar to convention, the sliding shaft in the present invention is attached at each end to two opposing door handles in order to hand operate the lockset unit. The sliding shaft in the present invention is a novel implementation in locksets and which integrates novel features embedded within and thereon its body to engage, retain, secure and mount other lockset members. The linear movement of the sliding shaft traversing along it's longitudinal axis is converted into rotational or pivotal movement by various mechanical linkages housed and mounted within the lockset unit, whereby the converted rotational movement assists in pulling or retracting the latch tongue to release the door. In other words, the described mechanical linkages cooperate together to create a linear or rotational actuator. In this invention the latch bolt has been shortened and intentionally shaped compared to conventional latch bolts to conserve materials and allow assembly of members within a smaller space. Furthermore, the improved lockset also features novel lockset mounting roses with a plurality of adjustable mounting brackets and apertures, whereas prior art have used separate parts, integration of these features on one member part further simplifies and reduces costs.

Hence, the teaching in this specification describes a novel latch bolt assembly and a sliding shaft assembly.

Furthermore, this invention allows for a door lockset to open a door by a push and/or pull operation with an integrated lockset locking mechanism. In eliminating the additional mechanical forces of rotation needed to perform a latch bolt retraction, the present invention has improved functionality with respect to ergonomics, simplicity in use, design and cost effectiveness (due to reduced number of parts and hence, less use of resources). The improved functionality of the invention is desirable for persons with limited physical movement such as; the elderly, people with disability and young children.

Furthermore, the change in operational movement allows for novel handle designs, such as but not limited to, decorative flat plates of varying shapes and designs in comparison to common knobs and levers. Although flat plate handles are common, they are seldom used as operable latching door handles. The increase in visual and physical area makes flat plate handles ideal for people with low visibility or limited movement to be able to easily sight and operate. These novel push or pull plate handles may also appeal to interior decorators and enhance architectural aesthetics.

In the prior art, namely US20150076845, a described lockset implements an arcuate camming feature interposed between the lever handles and an actuator. Upon handle operation (by pushing, pulling or rotation) the said arcuate camming feature is capable of longitudinally pushing a member (unknown as the pusher member) which operates the retractor arm (which is a lever) to retract the latch bolt. Furthermore, each handle on each side has it's own independent pusher member, arcuate camming feature, and actuator arm allowing the handle manipulations, described in brief above, on both sides. The disclosed lockset also features an additional adjustment assembly which may adjust the lockset to accommodate installation into various door thicknesses.

The above improved lockset in the art is cumbersome and complex in mechanical parts. The fixed spindle implemented in the disclosed prior art only functions to mount the assemblies described thereon, it does not actuate a latch bolt retraction nor does it rotate as convention nor slide as the present invention discloses. Compared to the lockset described herein, the prior art has more than twice the number of mechanical parts due to the fact that both sides of the lockset requires its own independent actuator and associated members. Thus, the cost of manufacturing and assembly of the parts would increase the cost to consumers significantly. Furthermore, a preferred embodiment of the present invention is adapted to adjust to different door thicknesses without the further implementation of an adjustable assembly or another additional mechanism, which has previously made prior art complex and problematic especially when attempting to integrate a privacy locking mechanism. The additional handle manipulations on either end of the handle levers may give the operator different methods of opening a door, however, many of the features become redundant when applied on a conventional pivoting door which only has one opening direction. The present preferred embodiments of the invention are able to achieve the object of opening a door in its most simplistic way without over complicating the mechanism.

In the prior art, namely, AU 200157992 A1 and similarly in AU 2007100620, the disclosed locksets are capable of retracting a latch bolt against a biasing mechanism actuated by pulling a lever. The said levers in these disclosed art base also form an operable handle. The prior art discloses, an actuator pushing an interconnecting plunger of the lock bolt and in turn retracting the lock bolt. This mechanism is then able to eliminate the rotational element commonly incorporated in conventional lockets to retract the latch bolt assembly. While the prior art can achieve the latch bolt retraction without rotational applied force upon a handle, it cannot retract the latch bolt by a pushing operation upon the door handle or lever. To open a door which pivots away from the operator, the lever in the said prior art must first be pulled and once the latch bolt is retracted, the operator must then push the handle or door whilst attempting to keep the lever in the pulled position. This limiting operation is somewhat awkward and counterintuitive when opening a conventional door that opens away from the operator.

The lever and pusher actuators described in the prior art above are commonly used with lockset handles to retract the latch tongue. However, the said handles in the prior art are still requiring a pivotal action to operate the lockset, the difference is that the pivotal axis is transverse in direction to the conventional axis of pivot. As described in the present invention, the implementation of a single longitudinally and linearly traversing shaft, which transverses through the lockset and the main plane of the door to operate a latch tongue retraction (without the pivotal action of the handles) does not exist in prior art. Furthermore, the lever or actuator described in the present invention does not only serve the purpose of actuation, but also in contrast to the prior art, it is shaped and formed specifically to be easily attachable and detachable to a subassembly (latch bolt assembly) of the lockset for ease of installation of the lockset onto a door. Thus, the preferred embodiments of the present invention integrate multifunction and multipurpose of these and other members of the said lockset, which will be further elaborated below. These improvements provide a more simplified, economical and ergonomic way of operating a door handle lockset compared to prior art.

In prior art, conventional door locksets are commonly installed into doors by simply first mounting the latch bolt assembly into a lateral bore of the door panel. Then a spindle which connects the two opposing door handles is inserted through an aligned axial aperture found at the rear of the mounted latch bolt assembly. The said spindle disposed therein and extending through the latch bolt assembly's axial aperture is the rotational actuator which operates the latch tongue retraction. The said spindle, door handles, roses and mounting screws are generally the only components which are required to assemble a conventional door lockset into a standard door. The simplicity in installing a conventional door lockset makes it desirable for use domestically and commercially. To install a door lockset whereby the actuation is by pushing or pulling a door handle is potentially more complicated than conventional door locksets. The present invention describes a novel apparatus and method of installing the preferred embodiment of the lockset which comprises; a novel latch bolt assembly and sliding shaft assembly connected or linked by means of complementing female to male mechanical linking features found respectively on each said subassemblies. The proceeding descriptions of the latch bolt assembly and sliding shaft assembly are not intended to be a limiting feature of the current invention. Members of each said assembly may be interchanged or adapted onto or into each said assemblies. Furthermore, the current invention may be also described with one lockset assembly. The purpose of distinguishing the two said assemblies is to demonstrate how the subassemblies link with each other to achieve the best mode of operational and fitting means.

The invention will be described primarily with reference to doors in residential and commercial premises, however, the preferred embodiments of the invention are adaptable to other opening and closing apertures, such as, windows, vehicle doors, pivot doors, etc.

### DISCLOSURE OF INVENTION

The invention achieves its object and other objects by means of a latch bolt assembly and a sliding shaft assembly, coupled or linked together to translate directional and linear movement of the sliding shaft into a movement assisting with or operating a latch tongue retraction.

A broad form of the present invention comprises; a spring loaded latch bolt assembly movable from first extended position and a second fully retracted position, which is mechanically linked with a sliding shaft assembly to actuate the said latch bolt or tongue between the said positions. In this preferred embodiment of the sliding shaft assembly, the actuator implemented is known as a ‘L’ shaped crank member pivotally mounted onto the interior face of a lockset rose and is operably linked to the said latch tongue. The said crank has two arms and pivots at the point where the arms meet. A sliding shaft member disposed across the two lockset roses through aligned shaft apertures permitting passage of the said member; for linear movement back and forth along it's longitudinal axis therethrough and transverse to the direction of the latch tongue movement. The said sliding shaft member embodies an engagement means to operably engage with one arm of the actuator. The other arm of the actuator is operably engaged with a corresponding linking means, which in this preferred embodiment is a female type connector of the said latch bolt assembly. Upon the said crank rotating, the latch bolt assembly which is linked with an arm of the said crank actuator may be pulled into ‘linear’ motion by the said arm (the rotating crank acting as the linear actuator), and in doing so, retracting the said latch tongue into second position. Furthermore, the positioning of the said mounted crank onto the interior face of lockset rose can be adjusted, in order to accommodate the variances in door thickness as will be described in detail further below.

To elaborate further, a push or pull operation upon the door handles causes the attached sliding shaft member to traverse perpendicular to the main plane of the door. In turn, the sliding shaft engages one arm of the said crank member, which then rotates the pivoting crank member simultaneously translating the traversing movement of the sliding shaft member (through a ninety degree angle around the pivotal axis of the crank) upon the other arm of the crank. Thus, the rotational motion caused by the pivoting crank also causes the arm which is operably linked with the latch bolt assembly, to pull and retract the latch tongue into the housing. Hence, releasing the latch and causing the door to open.

The sliding shaft assembly comprising of the two armed crank, described broadly above, is operable only in one rotational direction unless the assembly is rotated one hundred and eighty degrees (180°) about it's horizontal lateral axis. Rotating the sliding shaft assembly in this manner allows the said crank to rotate operably in the opposite direction. Elaborating further, the actuator can only retract the latch tongue if it was pushed from one side or pulled from the other side of the door. Therefore, the preferred orientation of the said sliding shaft assembly will need to be configured prior to installation by rotating the said assembly in the manner described above.

Conventionally, residential doors can only be opened in one direction, therefore, orientating the sliding shaft so that its operable direction is in alignment with the direction in which the pivoting door panel opens should be considered. For the purposes of residential and commercial doors, the sliding shaft assembly comprising the said singular crank mechanism would suffice. An alternative description of a preferred embodiment of the sliding shaft assembly which may be operable by either a push or pull from one side of the door is also described below. The push or pull door lockset operable both by pushing or pulling from either side of the door would be useful in doors, windows, or other opening apertures that can be opened in both directions.

In another broad form of the invention, the sliding shaft assembly comprising; an actuator assembly means interposed between the latch bolt assembly and the sliding shaft. The said actuator assembly means pivots at two points and rotates in two directions; as opposed to rotation in one direction of the previously disclosed crank actuator. By such means achieving latch tongue retraction upon both a pull or push operation of the sliding shaft member. The description and illustrations below will further detail the invention and the said actuation means.

In another broad form of the present invention comprises; a sliding shaft adapter assembly to engage with a conventional rotational latch bolt assembly through the conventional spindle aperture and operable therein and therethough. The aforesaid sliding shaft adapter member translates linear movement of the door handle into axial movement within the spindle aperture. The said sliding shaft adapter assembly further comprises: a twisted metal key member comprising of an integrated twist; a square tube or barrel member which the twisted metal key is inserted through an internal eye of the said member. As the key is inserted into the eye of the square tube, the twist of the key slides through the square tube therein simultaneously turning the square tube axially. This is due to the internal eye tracing the curved path along the twisted profile of the key section of the sliding shaft; provided that the twisted metal key maintains fixed orientation except longitudinally as the key moves into and through the eye. Thus, the integrated twist will cause the square tube to simultaneously rotate upon insertion. In this manner, the sliding shaft adapter assembly is able to achieve rotational actuation of the conventional latch bolt assembly.

In all broadly described embodiments of the invention; the said mechanical links, linking means, linear and rotational actuators features a male to female (or vice versa) connection type, wherein but not limited to: an arm, a rod, pin, joint, hook, spigot (male connectors) is inserted into; an aligned hole, aperture, clevis or mounting recess (female connectors) designed to link/connect/mate the two assemblies or members together.

In all three embodiments, the described sliding shaft is a universal essential integer of the disclosed inventive concept, also unknown as the ‘unity of invention’. In all three of the disclosed embodiments of the invention, the said sliding shaft is disposed transverse through lockset roses and is slidable back and forth therethrough. The said sliding shaft is formed and shaped with specific features which provide it with an engagement means, a biasing means, a locking means and a mounting means. The described actuators are usually coupled with the said sliding shaft in an assembly, however they vary in form and function.

A novel locking mechanism is also implemented into the preferred embodiments which is operable on either side of the lockset or door. The herein described novel locking mechanism also integrates a shaft biasing means, which further reduces parts and additional assembly members to conserve material and space.

By specifically dimensioning parts to fit within existing standardised door lockset bore cavities, the invention simplifies the method of installation. The integral design and use of simple male to female connecting or linking features of lockset subassemblies allows installation of the lockset unit, into residential and commercial premises, to be done by a layperson. The invention also allows for the replacement and retrofit of any existing conventional door handle lockset.

Further objects, features, advantages and properties of a push and/or pull door lockset and defined assembly members will become apparent from the detailed description of embodiments of the present invention when taken in conjunction with the accompanying drawings. However, the drawings employed herein are for the purpose of descriptions and should not be regarded as limiting.

### BRIEF DESCRIPTION OF DRAWINGS

The present invention will now be described according to preferred but not limiting embodiments and with reference to the accompanying illustrations wherein:

FIG. 1. A schematic illustration of an exploded view of a complete and preferred embodiment of the present invention.

FIG. 2. A schematic illustration of a partially exploded view of a preferred lockset assembly into two subassemblies namely; latch bolt assembly and sliding shaft assembly.

FIG. 3. A schematic illustration of the complete assembly of a preferred embodiment of the present invention.

FIG. 4. A schematic illustration of the complete assembly of a preferred embodiment of the present invention in actuated position.

FIG. 5. A schematic illustration of a sectional view of the complete latch bolt assembly inside the faceplate casing with the latch bolt in the first extended position taken along the line B.

FIG. 6. A schematic illustration of an exploded isometric view of the latch bolt assembly.

FIG. 7. A schematic illustration of the latch bolt tongue in isometric view showing hidden lines.

FIG. 8. A schematic illustration of the faceplate casing in isometric view showing hidden lines.

FIG. 9. A schematic illustration of the rear isometric view of faceplate casing.

FIG. 10. A schematic illustration of the crank of a preferred embodiment of the present invention.

FIG. 11. A schematic illustration of the first lockset rose of a preferred embodiment of the present invention with it's mounting and securing features shown on it's interior face.

FIG. 12. A schematic illustration in isometric view of the actuator, sliding shaft, the lock mechanism in locking position and shaft biasing means mounted onto the first lockset rose.

FIG. 13. A schematic illustration in isometric view of the sliding shaft member of a preferred embodiment of the present invention.

FIG. 14. A schematic illustration of an isometric view of an alternative sliding shaft and crank biasing mechanism, implemented between the actuator and first lockset rose.

FIG. 15. A schematic illustration of the locking mechanism mounted between the first lockset rose and sliding shaft in top view.

FIG. 16. A schematic illustration in exploded isometric view of the locking mechanism with the spring biasing means.

FIG. 17. A schematic illustration of the internal face of the second lockset rose.

FIG. 18. A schematic illustration of an alternate preferred embodiment of the present invention of the sliding shaft assembly and the latch bolt assembly.

FIG. 19. A schematic illustration of another preferred embodiment of the present invention in isometric exploded view.

FIG. 20. A schematic illustration of the complete lockset assembly with an alternate preferred embodiment of the sliding shaft assembly.

FIG. 21. A schematic illustration of an alternate sliding shaft assembly in operation, towards side B, retracting the latch tongue in sectional view.

FIG. 22 A schematic illustration of an alternate sliding shaft assembly in operation, when the sliding shaft member is actuated towards side A retracting the latch tongue in sectional view.

FIG. 23. A schematic illustration of the conventional latch bolt assembly and the sliding shaft adapter assembly in partially exploded isometric view.

FIG. 24. A schematic illustration of the conventional latch bolt assembly and the sliding shaft adapter assembly in exploded isometric view.

FIG. 25. A schematic illustration of the sliding shaft adapter assembly engaging the conventional latch bolt assembly in top view.

### BEST MODE FOR CARRYING OUT THE INVENTION

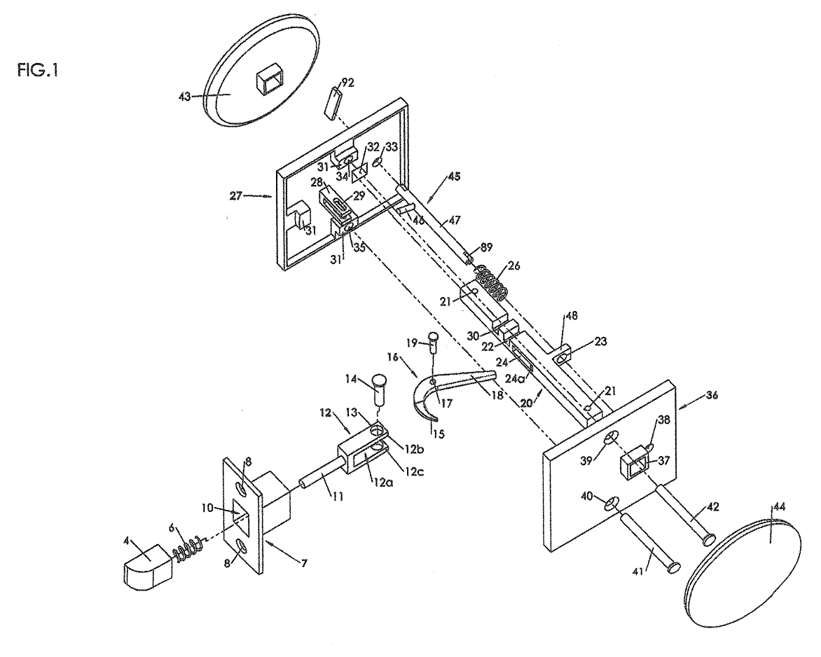

FIGS. 1-3, illustrates the exploded, partially assembled and assembled views of a preferred embodiment of the present invention which comprises the following subassemblies and members: a latch bolt assembly which is identified with the reference numeral 1; the sliding shaft assembly which is identified with the reference numeral 2; the lockset roses 27, 36; door handles 43, 44 and mounting screws 41, 42. The depicted orientation of the lockset assembly is not an intended necessary limitation of the invention. The proceeding detailed descriptions of the invention of the latch bolt assembly 1 and sliding shaft assemblies 2, 3 are not intended to be limiting features of the present invention. The members in each said subassemblies may be interchanged or adapted onto or into each stated subassemblies. Furthermore, the current invention may be also described with one lockset assembly. The purpose of describing the lockset unit with two subassemblies is to demonstrate how the subassemblies of the lockset unit achieves the objects of the desired operational and fitting means. Moreover, the said subassemblies in the said preferred embodiments allow ease of fitting or installation of the lockset unit into standardised door bore cavities.

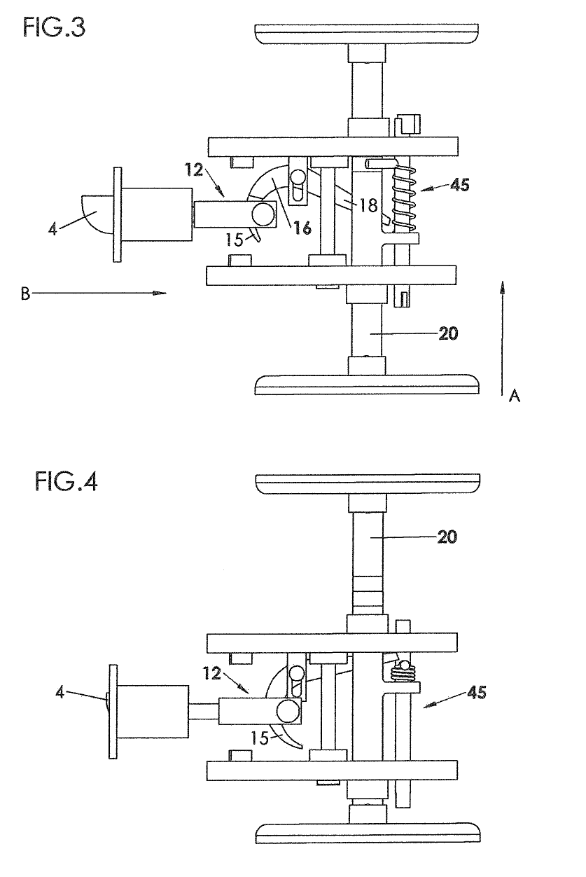

The orientation of the canted latch bolt tongue 4 depicted should be disposed one of two possible orientations, which depends on the direction of door closure. As with conventional latch tongue orientations when installed into the lateral bore of the door's edge, rotating the latch bolt assembly 1 one hundred and eighty degrees (180°) about it's longitudinal axis will simply change the orientation of the canted latch tongue 4. In a similar manner, the sliding shaft assembly 2 is adapted to be rotated one hundred and eighty degrees (180°) about the sliding shaft's horizontal lateral axis to change the operational direction of the actuation means. As depicted, the preferred embodiments of the said lockset subassemblies are designed with symmetry about the said axes of rotation. Thus, the said manner of rotation of the said subassemblies does not affect the overall function nor appearance of the lockset, except, for the shaft's direction of operation and the direction of the canted face of the latch tongue. Furthermore, when installing the sliding shaft assembly 2, the sliding shaft member 20 is preferred to be orientated onto the side of the door where the push of the door handle and in effect, pushing the sliding shaft member 20, is coincidental with pushing the said door panel into its opening position. As the sliding shaft member 20 can only be pushed from one side or pulled from the other side of the door, configuring the orientation of the lockset prior to installation is necessary (push or pull operation only in the direction of arrow ‘A’ shown in FIG. 3). Orientating the sliding shaft assembly 2 in the alternative direction to the preferred above is counterintuitive to the operator opening a door, but nevertheless possible. Alternative embodiments of a sliding shaft assembly 2, namely sliding shaft assembly 3, may be pushed and pulled on either side to release the latch tongue is also described hereinafter. Another preferred embodiment is a sliding shaft adapter assembly 93, mountable onto and into conventional latch bolt assemblies, will also be described further below. The following description of preferred embodiments also describes the best mode of installing or fitting the lockset into a door.

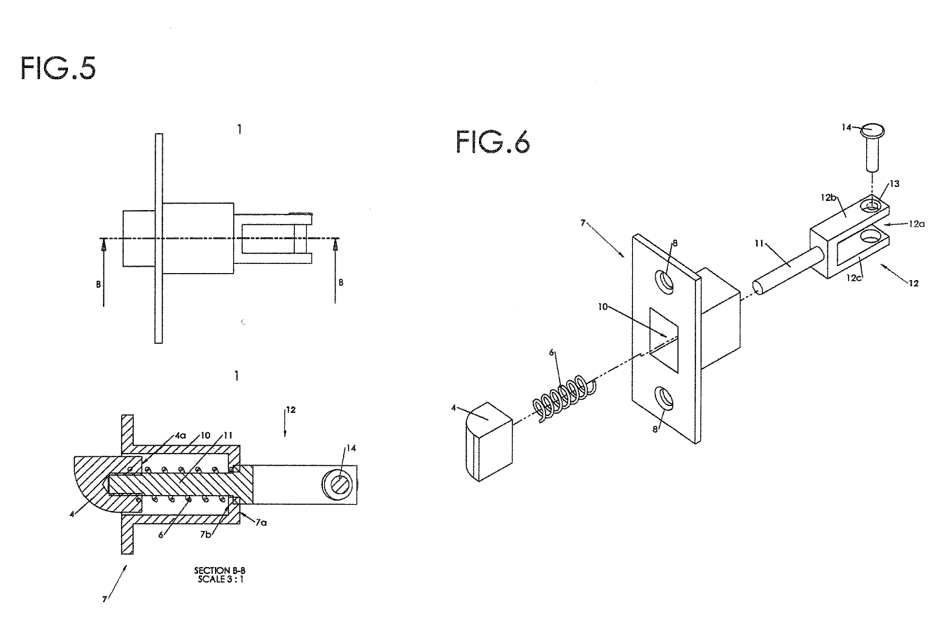

The FIGS. 5 and 6 illustrates the latch bolt assembly 1 in its preferred assembled embodiment in a sectional view along the line B and an exploded view. The latch bolt assembly 1 comprises: a latch tongue 4 movable from first latched position to second retracted or unlatched position; a biasing means, namely, compression spring 6 to urge the latch tongue 4 into first position; a faceplate casing 7 to house the latch tongue 4 and its associated members stated above; a rearward connecting rod 11 with a linking means 12, which is in this preferred embodiment an elongated clevis (however, it is possible to have a round hole, mounting recess or a male linking feature); and a clevis pin 14.

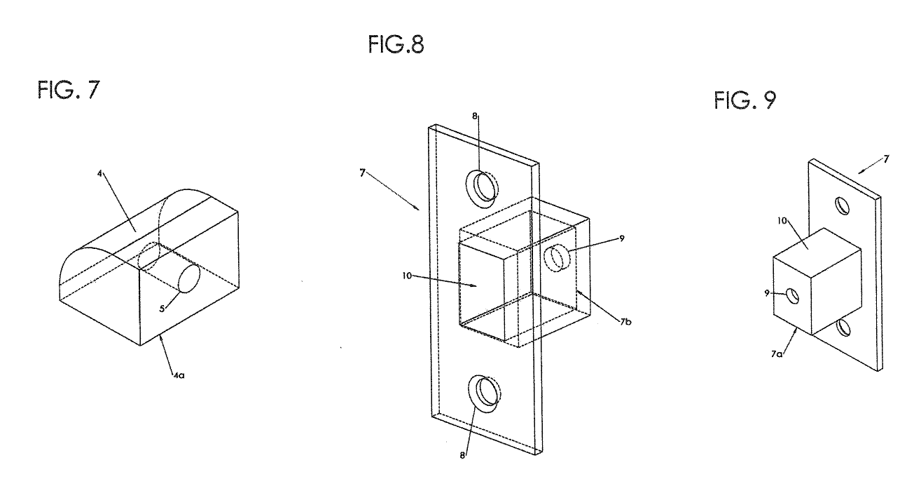

Now further describing the preferred embodiment of latch bolt assembly 1 and detailing the best mode of assemblage, referring to FIGS. 6-9. The rearward connecting rod 11 comprises: a linking means 12; and a clevis pin 14, alternatively, an eye bolt, inter alia may also be used instead of the connecting rod. The narrow distal end of the connecting rod 11 is inserted through the small round hole 9 at the back of the faceplate housing 10. The lateral projections of the clevis arms 12b,12c from the connecting rod's 11 cylindrical body acts as shoulders, which engages the back face 7a of the housing 10, impeding the full extension of the connecting rod 11 through the small round hole 9. The connecting rod 11 then receives the compression spring 6 by inserting the said connecting rod's distal end through the said spring. The distal end of the connecting rod 11, which is pre-threaded (not shown), is then fastened into the latch tongue 4 by means of a threaded hole 5 located centrally at the rear face 4a of the latch tongue 4. The clevis pin 14 is run through the clevis pin holes 13 to complete the latch bolt assembly 1 with biasing means spring 6 housed and retained within the faceplate housing 10.

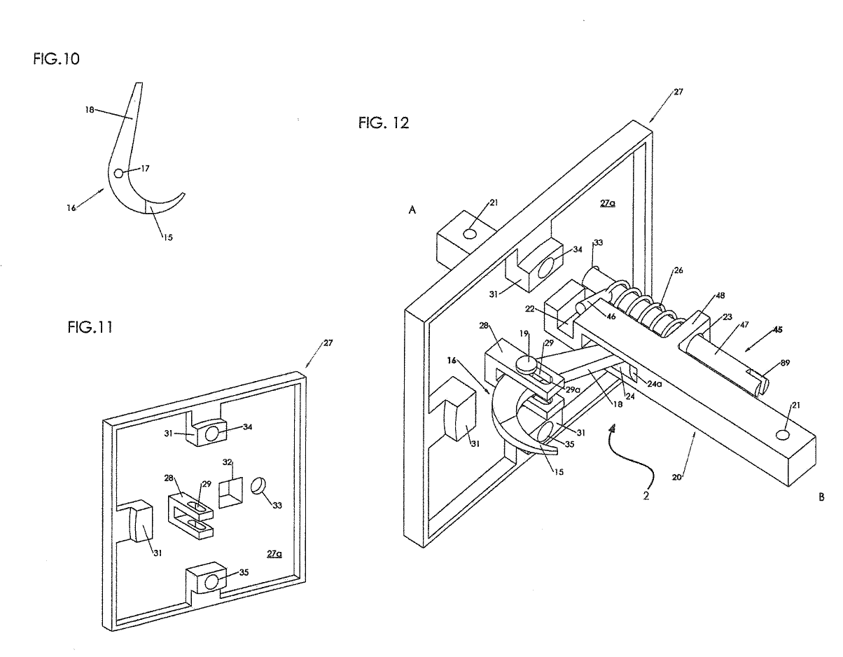

The said clevis pin 14 has a clearance fit within the clevis holes 13. This allows the clevis pin 14 to freely rotate within the clevis holes 13 which facilitates a reduced frictional contact surface upon operation by the complementary male linking member, namely, the linking arm 15 of the actuator 16 (FIG. 10).

As illustrated in FIGS. 5-8, the faceplate housing 10 is sized to fit the entire length of the latch tongue 4. As shown in FIG. 5, the first fully extended position of the canted latch tongue 4 in the faceplate housing 10 only partially projects the full length of the latch tongue 4. This ensures that part of the extended latch tongue 4 is positioned to remain in contact with the door by means of the faceplate casing 7 and the remaining tongue in the striker plate recess (not shown), this provides the door with securing means. As with conventional faceplates, the present faceplate casing 7 comprises: an open housing 10 to accommodate the latch tongue 4 and compression spring 6, two screw holes 8 positioned top and bottom of its face for door fixing, and a small centred round hole 9 at the rear face for insertion, retaining and guiding the connecting rod 11, and biasing means, namely spring 6.

The said compression spring 6, is retained and interposed between the rear face 4a of the latch tongue 4 and the faceplate housing's back wall 7b (FIGS. 5-8). The said spring is positioned and secured inside the faceplate housing 10 and maintains alignment and position by means of the connecting rod 11. This allows a diametrically smaller compression spring to be fitted and further reduces costs. The compression spring 6 creates a latch tongue bias in the first extended or latched position. Upon latch tongue 4 retracting into second position, the said spring 6 is compressed by the rear face of the retracting latch tongue 4 against the internal rear wall 7b of the faceplate housing 10. By such means, compression of the said spring is achieved and thus creating elastic potential energy to extend the latch tongue 4 back into extended first latched position after operation.

Comparably to conventional straight, solid and long bodied ‘latch bolts’, ‘latch means’ or ‘locking tongues’ in prior art, the preferred embodiment of the latch bolt in the present invention has an intentionally adapted, sized and shaped body comprising: a latch tongue 4; a narrow part 11; an aperture 12a with projected parts 12b, 12c; a linking means 12 to link, engage, retain and mount other members of the assembly described above and hereinafter. The said latch bolt also allows more space for assembly members to be integrated and cost effectiveness.

This completes the preferred embodiment of the latch bolt assembly 1 into the faceplate casing 7, wherein an extended latch bolt tongue 4 is housed and therein extended in first position by means of a compression spring 6 bias. The said assembly is then mounted into the lateral bore on the edge of the door (not shown). The said latch bolt assembly 1 is capable of fully retracting into the faceplate housing 10 sized to fit the entire length of the latch tongue 4 and compression spring 6 as seen FIG. 5. In a preferred embodiment of the latch bolt assembly 1, the canted latch tongue can autonomously retract upon engaging a striker plate (not shown) mounted on the adjacent doorframe or if pulled from the rearward clevis, namely, the linking means 12. This is due to the elongated aperture 12a, which is capable of retracting further into the door cavity upon latch tongue 4 retraction without engaging the linking arm 15.

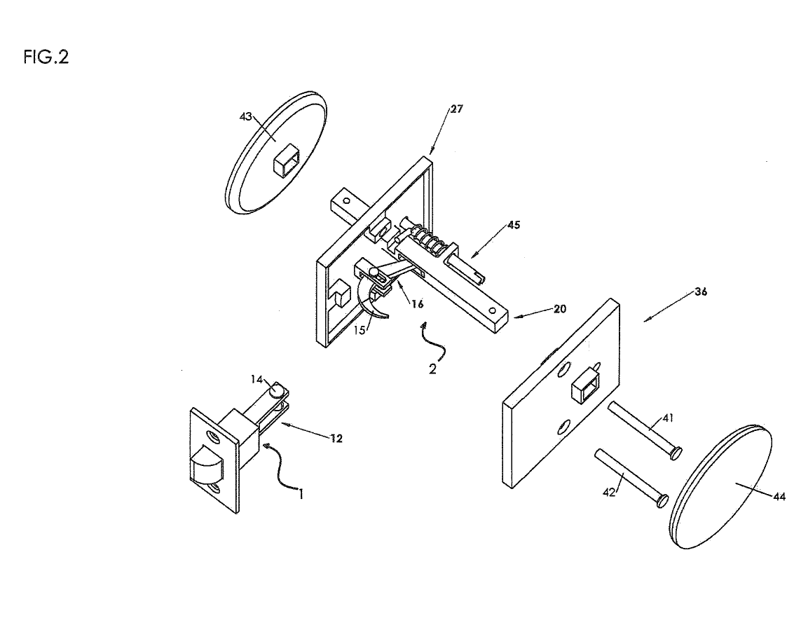

Referring now to FIG. 2, the best mode to mechanically linking the latch bolt assembly 1, described above, to the sliding shaft 20 and thereon to the door (not shown) will now be elaborated. An essential integer of the present invention to achieve the above described link and door installation is by means of the latch bolt assembly's linking means 12, which links but does not affix itself to the sliding shaft assembly 2. The sliding shaft 20 and its associated members hereinafter described as the sliding shaft assembly 2, allows the sliding shaft 20 to be operated from first resting position (FIG. 3) to second operating position (FIG. 4). Furthermore, the sliding shaft assembly 2 may be described without the sliding shaft 20, in such case, the said assembly may be described as an actuator assembly (not shown). The sliding shaft 20, may facilitate a desired latch tongue retraction through various mechanical linkages or in this preferred embodiment, an actuator assembly. In this preferred embodiment of the invention: the first lockset rose 27; an actuator 16; a locking mechanism 45 with integrated biasing means 26; are specifically disposed and mounted to form the desired mechanical linkages and actuation means.

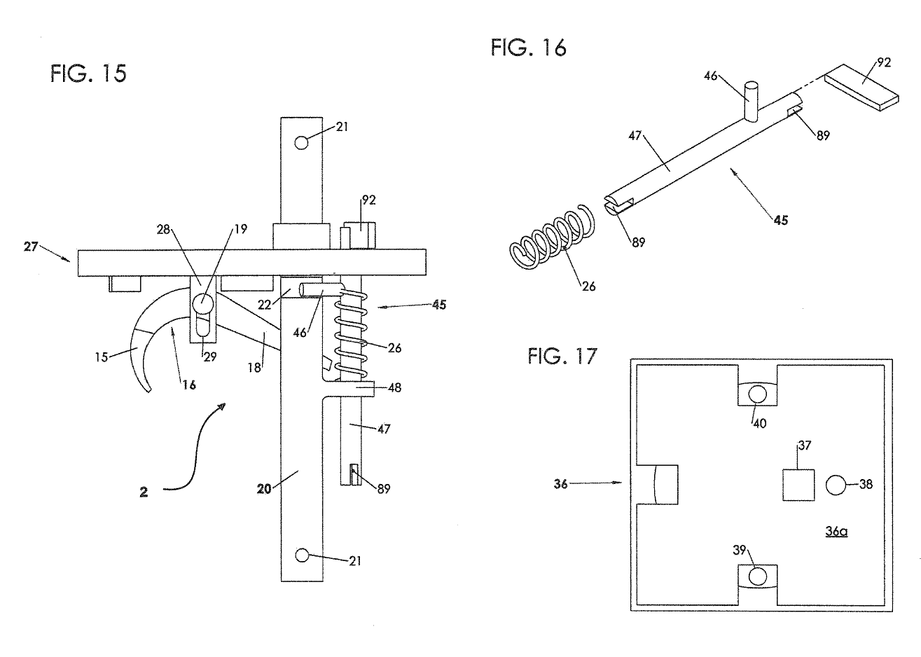

Referring now to FIGS. 11 to 13, which illustrates a preferred embodiment of the first lockset casing with it's mounting means, a sliding shaft 20 and the sliding shaft assembly 2. The sliding shaft assembly 2 comprises: a first lockset rose 27 (which may be any shape; round, oval, rectangle or square); a crank mechanism or hereinafter termed actuator 16; a sliding shaft 20; locking mechanism 45, and shaft biasing means or compression spring 26. The said first lockset rose 27 further comprises on it's interior face 27a: a plurality of mounting means 28, 29, 31, 32, 33; the said mounting means 28 is, but is not limited to, a pin or bored bracket or ledge to pivotally mount the actuator 16, a bored ledge 28 and it's corresponding elongated bored mount slot 29 is the preferred embodiment of the present invention; a plurality of door cavity mounting bosses 31 are radially disposed internally with tapped screw holes 34, 35 which allow mounting screws 41, 42 to be fastened therein; said screws extend through and from the second lockset rose screw holes 39, 40 (second lockset rose, see FIGS. 1 and 17), therein enclosing and securely mounting the lockset onto the door (not shown); the sliding shaft 20 which is disposed with one end depicted as ‘A’ through the first rose's said mounting means, namely, shaft aperture 32. The said sliding shaft 20 comprising a bored lateral projection 48 to retain thereon the shaft biasing means, namely compression spring 26, and also therein and therethrough accommodating a locking mechanism 45 (see FIGS. 15 and 16). Said compression spring 26 is interposed between the locking mechanism's latch arm 46 and bored lateral projection 48 and which provides the sliding shaft 20 with biasing means to urge the sliding shaft into first resting position. A cylindrical bodied lock rod 47 of the locking mechanism 45, guides, positions and retains the said compression spring 26 thereon during the operation of the sliding shaft 20. A projected latch arm 46 of the lock rod 47 pivotally engages into lock sockets 22, 30 and therein immobilises the sliding shaft 20. The said lock sockets 22, 30 can be disposed on the top side, bottom side or both top and bottom sides of the shaft. In another preferred embodiment of the sliding shaft, both top and bottom sockets may have latch arms therein aligned to be engaged by rotation in either direction of the locking rod with multiple latch arms (not shown). The above description of a preferred embodiment of the locking mechanism 45 can achieve two objectives of the invention, that is: it can be used to guide and retain the sliding shaft's biasing means; and also upon rotational engagement with the sliding shaft's lock sockets 22, 30, it immobilises the sliding shaft from operating. The locking mechanism 45 herein described can be used in novel privacy locksets and will be described further in detail below. The sliding shaft 20 further comprises: handle mounting screw holes 21; said locking sockets 22, 30; and an integrated engagement means 24, which is in this preferred embodiment a bored slot embedded into the body of the sliding shaft 20 to house and engage with the longer arm 18 of the actuator 16. An actuator 16, which is a ‘L’-shaped crank, comprising arms 15,18 and which is interposed between the linking means 12 and said engagement means 24 whilst also linking and engaging with said means, respectively (see FIG. 3). A pivot bolt 19 which secures the actuator 16 onto the actuator mounting means, ledge 28, and thereon mount slot 29, which orientates the pivoting axis of the said actuator 16 perpendicular to the operational plane of the latch tongue 4 and sliding shaft 20 (see FIGS. 11 and 12). The said ledge 28 comprises an elongated mount slot 29 capable of mounting the actuator 16 at variable distances from the interior face 27a of the first lockset rose 27; to adjust the actuator 16 from standard 35 mm door to a 45 mm thick door.

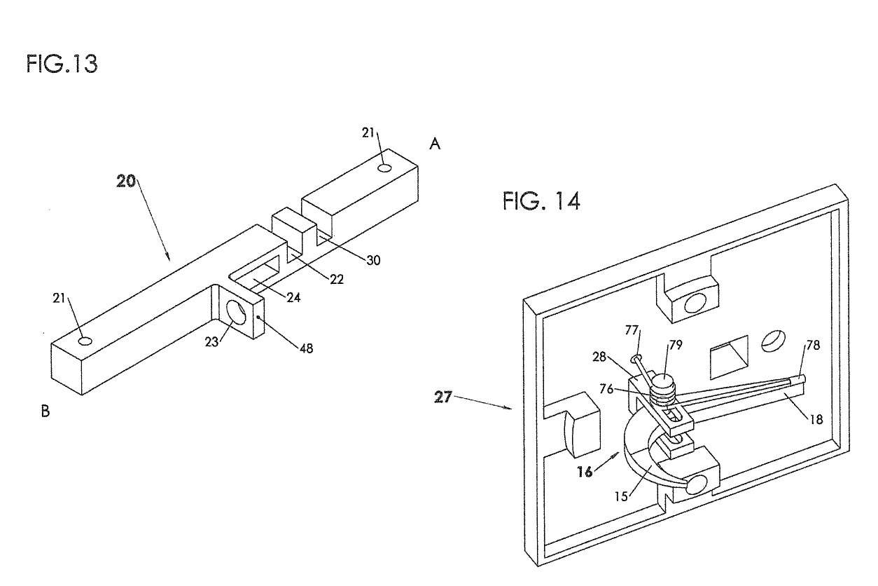

The best mode of assembly of the sliding shaft assembly 2 as seen in FIGS. 12 and 13 will now be described. The ‘A’ end of the sliding shaft member 20 is inserted into the sliding shaft aperture 32 found on the lockset rose 27. Ensuring that the orientation of the sliding shaft's spring rod hole 23 is aligned with the lock holes 33, 38 on the first and second roses 27, 36, respectively. The distal end of lock rod 47 is inserted into compression spring 26 and said spring is mounted thereon and kept in place by abutting against the latch arm 46 of the said lock rod 47 (see FIG. 16). The same distal end of the lock rod 47 is then inserted through the spring rod hole 23 of the said sliding shaft, which has a clearance fit diameter to allow the lock rod 47 to slide back and forth therethrough with less resistance. Its preferred that hole 23 has a diameter smaller than the inner diameter of spring 26, which precludes the inadvertent insertion of said spring therein or therethrough and retains said spring thereon projection 48. Furthermore, hole 23 is not a limitation of the preferred embodiment, and a ‘U’ shaped grooved slot may also be implemented thereon instead. The other distal end of said lock rod 47 is then inserted into the lock hole 33 of the lockset rose 27. Latch arm 46 will abut against the internal face 27a of the lockset rose 27 when it is not engaged within the lock socket 22; as spring 26 forces it thereon (not shown) and said force keeps the said latch arm in place and position against face 27a. An optional superficial linear channel (not shown) maybe milled on the face 27a in alignment with latch arm 46 so that when it is rotated thereon (once disengaging the locking mechanism), the said channel may prevent the latch arm therein from freely moving about and inadvertently slipping back into the lock sockets upon frequent and rigorous shaft operation. Furthermore, the said latch arm 46 impedes the locking mechanism's full extension out of the lockset roses, and effectively fixing its movement longitudinally but not axially. This also effectively retains and interposes the said lock rod 47 and compression spring 26 between the lockset rose 27 and the sliding shaft 20 by means of a fixed bored lateral projection 48. Said projection 48 is disposed off-centre onto the rear side face of the said sliding shaft 20. The said projection 48 serves multiple purposes in which it acts as a shoulder, retainer or stopper against the said compression spring 26, it also acts as a shoulder, retainer or stopper for the sliding shaft 20 against the internal face 36a of the second lockset rose 36 (see FIG. 17). Moreover, projection 48 prevents the said sliding shaft from being over extended by the spring 26 and being disengaged from the actuator arm 18. The bore or namely, hole 23 on the projection 48, also acts to position and align the distal end of the lock rod 47 with the lock hole 38 for ease of installation. As stated above the bore (hole 23) of the projection may also be a groove shaped into a ‘U’ capable of receiving and retaining the lock rod 47 and spring 26 therein and thereon. The mounted lock rod 47 and compression spring 26 guides, retracts and urges the sliding shaft member 20 into first position after it is operated from second position. Thus, the above described members are assembled in such a manner to create a sliding shaft biasing means.

Referring now to FIG. 12, the longer arm 18 of actuator 16 is then inserted and extends through the sliding shaft's body through engagement means 24, which in this preferred embodiment, is an integrated slot which has a curved interior edge 24a. Edge 24a assists the longer arm 18 to maintain constant contact with the sliding shaft member whilst the said arm adjusts to appropriate radius upon the actuator rotating. The engagement means 24 is not limited to a bored slot and alternatively, a lateral pin, recess, etc. may also be implemented. The engagement means 24 allows the longer arm 18 of the actuator 16 to be constantly engaged, upon linear movement of the sliding shaft member 20 into second position and in turn, simultaneously rotating the actuator 16 about it's pivotal axis point 17 by means of pivot bolt 19. The length between the point of contact of the longer arm 18 with the engagement means 24 and the crank's pivoting point 17 (FIG. 10) is variable with the movement of the sliding shaft 20. Thus, to allow the said mechanism to function properly the longer arm 18 of the actuator 16 does not have a conventional joint which is affixed to the sliding shaft member 20. Thus, the longer arm 18 is ‘loosely’ engaged to the said sliding shaft member 20. The actuator 16 is then mounted onto the said ledge 28 of the lockset rose 27, orientated with the distal end of linking arm 15 directed away from the lockset rose 27. The pivot bolt 19 is then run through the mount slot 29 and the actuator 16 pivoting axis point 17 (see FIG. 10) securing the said actuator 16 thereon in place. The pivot bolt 19 may be a bolt and nut (not shown). The lockset unit is adapted to be installed onto different door thickness standards, namely 33 mm and 45 mm thicknesses by means of the elongated mount slot 29. To achieve this, the mount slot 29 is adapted to mount the actuation means further away from the main plane of the first lockset rose 27 or face 27a. Moreover, the far end of the mount slot 29b corresponds to an actuator mount position for a wider door thickness (see FIG. 12). This allows the repositioning of the actuator 16 to be more central within the door bore cavity of a corresponding thicker door. The lockset unit may be preassembled at the factory with the actuation means selectively mounted at either distances. Alternatively, the installer may choose to adjust this feature at the time of install, by unscrewing or loosening the pivot bolt 19 (comprising of a small bolt and nut, not shown) and then sliding the actuator 16 to a different position within the mount slot 29 in accordance to recommendations of the installation guide. Furthermore, the mount slot 29 may be separated into two single mounting holes (not shown) which may require dismounting of the actuator and re-installing it onto the alternative mounting hole.

Upon operating the sliding shaft 20 into it's second position (see FIG. 4) towards arrow A (FIG. 3), the engagement means 24 engages the longer arm 18 of the actuator 16. As the long arm 18 traverses in the direction of arrow A, the linking arm 15 simultaneously traverses in the direction arrow B (see FIG. 3) and in turn engaging and pulling the linking means 12 of the latch bolt assembly 1 in the same direction. Thus, retracting the latch tongue 4 into it's second position (see FIG. 4).

These members in the preceding paragraphs are assembled to form the mechanism in which the latch bolt assembly 1, as described above, can be operably linked with through it's linking means 12 and operated into second retracted position. However, it is not an essential limitation of the preferred embodiment of the sliding shaft assembly 2 or latch bolt assembly 1, to comprise only the above said members. Individual members on each said assemblies may be adapted or interchanged onto the other assembly, or to subsequently form one or several lockset subassemblies. An example of this is described further below where the linking means 50, sliding adapter 51 and lockset rose 53 may be described as an actuator assembly.

Referring now to FIG. 2, the best mode or method of linking the latch bolt assembly 1 and sliding shaft assembly 2 as described above will now be described in detail. The latch bolt assembly 1 and the sliding shaft assembly 2 comprises: corresponding female to male linking features which are in the preferred embodiment the linking means 12 and linking arm 15, respectively. These features can be shaped and formed into, but not limited to: a hole, an aperture, a socket, an eye or mounting recess (female linking means) aligned to a corresponding; hook, a pin, bolt or spigot (male linking means). In a preferred embodiment of the invention, the linking means 12 comprises: clevis arms 12b,12c; clevis pin 14; and clevis aperture 12a, which may also be simply, but not limited to, an eye bolt. Correspondingly, the sliding shaft assembly 2 comprises of a linking arm 15 shaped as a hook. The linking features described above may be adapted or interchanged onto each said members, for instance, the connecting rod 11 could comprise of a hook at it's rearward end instead of a clevis. Correspondingly, the linking arm 15 of the actuator 16 could be shaped into a closed loop (not shown) which may receive the corresponding linking hook. The linking features may also be varied in shape, size and include any other mechanical linking/fastening methods. In the present invention it is preferred that the distal end of the said linking arm 15 is curved to facilitate retention and easy insertion into the said connecting rod's clevis aperture 12a, which is created by elongated clevis arms 12b, 12c, which also ensures ease of linking, assembly and installation. The linking arm 15 is secured in the linking means 12 by means of a clevis pin 14 which is inserted and secured into the clevis holes 13. The linking arm 15 makes direct contact with the clevis pin 14 and in doing so, effectively hooking it and preventing the arm from slipping out of the clevis. The clevis pin 14 is free to spin within the clevis holes 13 having a clearance fit circumference therein. The above described link does not mechanically fix the linking arm 15 to the latch bolt assembly 1, but merely allows surface contact between the described linking members. The free spinning clevis pin 14 allows the reduction of surface friction during the movement of the linking arm 15 against clevis pin 14 upon the actuator 16 rotating. It also allows the linking means 12 to smoothly traverse along the inside curved surface of the linking arm 15. The oversized connecting rod clevis aperture 12a also serves to temporarily detach or disengage the latch bolt assembly 1 from the linking arm 15 of the sliding shaft assembly 2, when the latch tongue 4 engages the striking plate (not shown) during a door closure. This said feature allows autonomous operation of the latch bolt assembly 1 from the rest of the lockset assembly members. Furthermore, upon closing the door, the latch bolt will independently retract without door handles 43, 44 being inadvertently operated. The above description of linking the aforesaid subassemblies completes the best mode of mechanically linking the assemblies.

The best mode or method of lockset installation of the preferred embodiment of the present invention is detailed in the proceeding paragraphs. The illustration in FIG. 2 may assist with the following description. The two subassemblies 1, 2 (latch bolt assembly and sliding shaft assembly) may be preassembled at the factory. The said two aforesaid subassemblies 1, 2 second lockset rose 36, two fastening screws 41, 42 and two door handles 43, 44 are the essential components which are needed to complete the lockset installation into a door. The screws which secure the latch bolt assembly into the side edge of the door and the striker plate are omitted hereinafter as these are standard features in the art.

The method of installing the door lockset into a standard pre-bored door lockset cavity is achieved by first mounting and fixing the latch bolt assembly 1 into the door's side edge bored cavity (not shown). Then by manually pushing the latch tongue 4 into the faceplate housing 10, the linking means 12 will extend further into the door's main bore cavity. This provides a larger linking and alignment area of the clevis aperture 12a for the insertion of the distal tip of the linking arm 15. In comparison to prior art lockset installations, namely conventional latch bolt assemblies and spindle-handle assemblies, the spindle apertures (usually a square hole) are aligned with a distal end of the spindles for the insertion of such therein and therethrough, i.e. female to male connections. Similarly to prior art, a preferred embodiment of the present invention comprises of the linking mean's 12 aperture, which is similarly aligned with a male linking arm of the actuator for insertion. The difference in this preferred embodiment is that the male linking feature is not the spindle or a shaft, but an actuator or an actuator assembly (mechanical links) of the sliding shaft.

The preferred embodiment of the sliding shaft assembly 2 may be mounted on either side of the door panel (not shown). However, for the best mode of operating the invention, the sliding shaft assembly 2 is preferred to be mounted onto the side of the door where; the door is opened by pulling the door handle 43, and in turn, the said door in the direction of arrow A seen in FIG. 3. The sliding shaft assembly 2 includes retaining bosses 31, disposed radially from the centre of the interior face 27a of the lockset rose 27. By such means, the said rose and sliding shaft assembly 2 may be secured and retained within the door's main bore cavity periphery.

Once the sliding shaft assembly 2 is orientated to it's preferred door side and aligned such that the distal tip of the linking arm 15 is directed into the clevis aperture 12a, it is then inserted into the door's main bore cavity. Once the sliding shaft assembly 2 is inserted into the door's bore cavity, it is secured by the rose's circumferential retaining bosses 31, which are dimensioned to fit within the door's bored cavity periphery. The manual release of the said latch bolt tongue 4 from the faceplate housing 10 will allow the latch bolt's linking means 12 to catch and engage with the linking arm 15. The second lockset rose 36 is then inserted onto the other side of the bored door's face, ensuring the linking arm 15 is engaged within the linking means 12 and that the other distal end “B” of the sliding shaft member 20 is inserted into the shaft aperture 37. The locking mechanism 45 and it's distal end should also be in alignment with its receiving lock hole 38 and be inserted thereinto in the same manner. The second lockset rose 36 is then secured by two mounting screws 41, 42 which are inserted into the lockset rose's mounting holes 39, 40 and which extends therein through the lockset housing cavity and fastened into their respective screw holes 34, 35. A locking lever 92 is then mounted onto one end of locking mechanism 45, preferably on the side where a lock is desired. Lastly, door handles 43, 44 are attached to the ends of the sliding shaft by means of small screw holes 21 on the sliding shaft 20, whereby, but not limited to a small socket head screw (not shown) is used to fix the said handles into the said screw holes 21. This completes the preferred method of installing the preferred embodiment of the door lockset.

Illustrated in FIG. 14, is the preferred embodiment of an alternative sliding shaft biasing means. The preferred embodiment of the sliding shaft member 20 and it's spring biasing means described above, can be also be achieved with a torsion spring 76 bias or another compression spring (not shown) mounted between one of the actuator 16 operating arms 15,18 and the first lockset rose 27. The lockset rose 27 has spring mounting retention means 77 and similarly, a mounting and retention means 78 on the actuator 16. The spring and crank pin 79 secures both the torsion spring 76 and actuator 16 in place on top of the ledge 28. The torsion spring 76 forces the actuator's longer arm 18 against the sliding shaft 20 via engagement means 24 towards lockset rose 36. This described alternative of the sliding shaft bias mechanism can be used in combination with the spring biasing means, described in the preceding paragraphs, whereby the two described biasing mechanisms can assist the sliding shaft member 20 to retract back into first position after operation. However, the two sliding shaft biasing means is not an essential limitation of performing the latch bolt retraction upon actuation of the sliding shaft member. This feature may be omitted from the preferred embodiment. However, the accumulative weight and friction of the door handles on either side of the lockset may cause resistance to the overall functional efficacy of the lockset, particularly upon the latch bolt assembly 1 and upon it's own biasing means 6 therein. Once the sliding shaft is operated upon by means of handle operation and thereby retracting the latch bolt, the resistance from the door handles and sliding shaft against the internal friction of the lockset roses may impede repositioning of the said sliding shaft and said latch bolt. Thus, the latch tongue may not extend back into position unless a spring 26 with higher stiffness is implemented.

As illustrated in FIGS. 15, 16 and 17, a preferred embodiment of the lockset handle locking mechanism 45 will now be described further below. The following description of a rotatable locking mechanism 45 is desirable for use in a novel ‘privacy’ lockset. The locking mechanism 45 comprises: a cylindrical and rotatable lock rod 47 which is mounted and retained between the two lockset roses 27, 36 by means of lock holes 33, 38 on the said roses, respectively; and the said lock rod's 47 longitudinal axis is disposed in parallel alignment with the longitudinal axis of the sliding shaft 20. The lock rod 47 comprises: without limiting the possible alternate features, multiple latch arms or cams, or in this preferred embodiment; a laterally protruding latch arm 46 which is disposed closer to one end of the lock rod 47, which operably engages upon axial rotation about it's longitudinal axis into aligned lock sockets 22, 30 on the sliding shaft 20 (FIG. 13). Hence, immobilising the said sliding shaft 20 once therein engaged. Multiple latch arms are possible (not shown), particularly, where two latch arms are disposed at an angle (preferably between 60 to 180 degrees) about the longitudinal axis of the lock rod; such that the axial rotation of the locking rod in a clockwise and anticlockwise direction could effectively lock the sliding shaft. This would be a useful feature to allow the lockset to be locked in either rotational direction of the lock lever 92. Lever mounting means 89 are found at each end of the lock rod 47 to mount a knob or lever 92, to pivotally operate the said rod into locking or unlocking positions from either end.

The lock socket 30 (as seen in FIG. 13) on the sliding shaft 20 corresponds to the locking accommodation for a thicker door (a 45 mm door thickness). If the lockset is adjusted to be installed onto the said thicker door, socket 30 will then be aligned with the said latch arm 46 and which will provide the locking means therein. As described above, once the latch arm 46 is engaged therein into either lock sockets 22 or 30, the said arm will simultaneously abut against the interior face 27a of the first lockset rose 27. This hinders the attempted movement of the sliding shaft 20 through the shaft apertures 32, 37 (see FIG. 12). In turn, this prevents the movement of the sliding shaft 20 and further prevents its engagement with the actuator 16 to operate the latch tongue retraction. The latch arm 46 has also spring retaining means to retain the spring 26 which is interposed between said latch arm 46 and the sliding shaft's lock rod guide and spring retainer, projection 48, to retract and urge the sliding shaft 20 after operation from second position. The said latch arm 46 is disposed at the depicted end to prevent the rod from being pushed out of its hole 33 inadvertently by the actuation of the sliding shaft 20. Furthermore, the projection 48 abuts the internal face 36a of lockset rose 36 and prevents the operator from pulling the sliding shaft 20 and the locking rod 47 out of position. The spring 26 also assists the locking rod 47 in repositioning the said rod once the sliding shaft retracts into first resting position by exerting an equal but opposite force onto the latch arm 46 towards the internal face 27a of lockset rose 27. The locking lever 92 which may also be a knob, may be easily mounted to either side of the door into or onto mounting means 89 depending on the side which a lock is desired. As the locking rod 47 extends through both roses 27, 36, the lock may be unlocked or locked at either end or sides of the door. This feature allows the lockset to be unlocked in case of an emergency from either side. The above description of the preferred embodiment of the locking mechanism 45 achieves two objectives of the invention; a handle locking means and a sliding shaft retracting means.

It is noted that there are a plurality of mechanisms to create a mechanical linkage between the sliding shaft member 20 and a latch bolt assembly 1, to achieve an actuation means to translate the direction of linear movement of the said sliding shaft to operate a latch bolt retraction. Examples of alternative mechanisms to link the said assemblies include an unillustrated simple pulley system; whereby a string is tied between the latch bolt assembly 1 and the sliding shaft member 20 with a fixed pulley interposed between the said members; to guide the said string and change the direction of the traversing sliding shaft member 20. Another unillustrated example includes a rack and pinion linear actuator, whereby two racks are positioned perpendicular to each other with the pinon and it's rotational axis positioned in between and perpendicular to the plane of the said transversing racks and the pinion's gear teeth engaging the linear row of teeth on both racks. The rotational motion applied to the pinion causes both racks to move in two different directions simultaneously. Conversely, the linear motion exerted on one rack is translated into the linear motion of the second rack in another direction by means of the inter-engaging rotating pinion. The examples above are not comparably desirable to the present preferred embodiment of the invention, as they require further intricate mechanical parts, precision in assembly and complicated in installation. Thus, these above examples and prior art do not have an advantage in manufacturing and cost effectiveness over the preferred embodiments of the present invention. Furthermore, the present invention describes a far more robust mechanism to translate direction of linear movement.

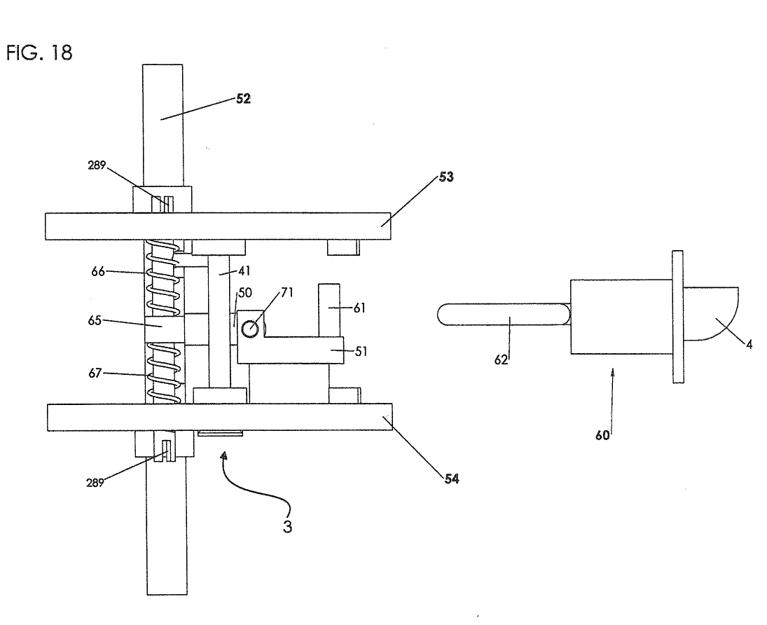

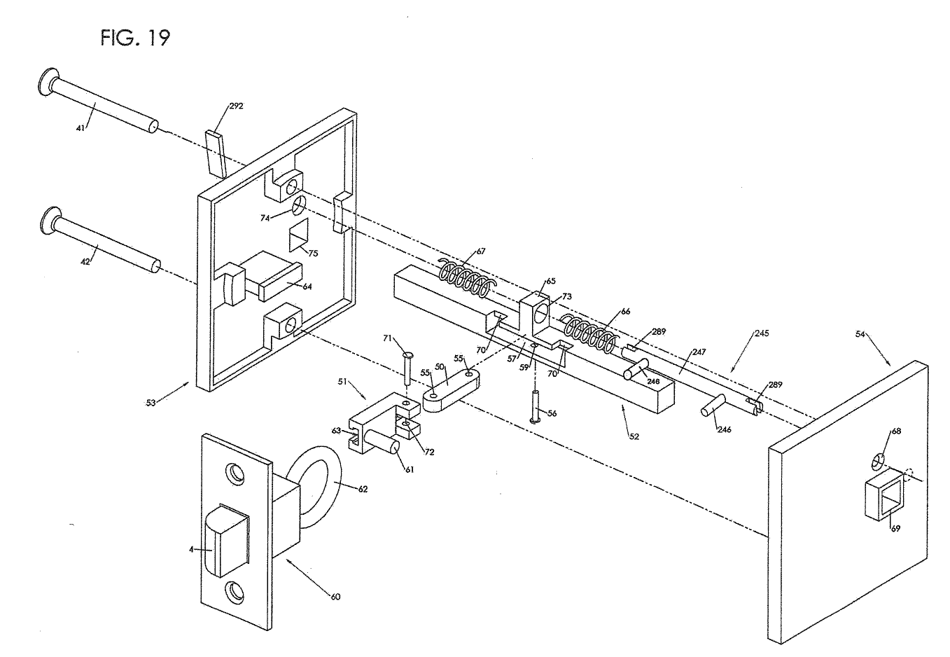

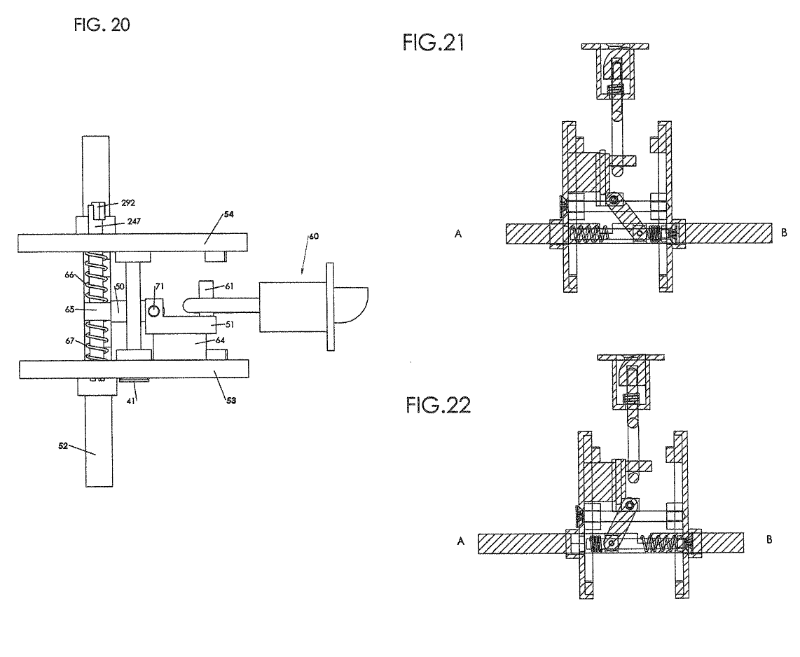

Illustrated in FIGS. 18-19, is another preferred embodiment of the sliding shaft assembly of the present invention. The alternate assembly as described hereinafter is the sliding shaft assembly 3, comprising: a rigid link 50 including two joints or holes 55 to be affixed to the sliding shaft 52 at one joint; and the other joint to the latch bolt assembly 60 through an intermediary member described herein as a sliding adapter 51. The said intermediary member is not intended to be a limitation of the present invention and the assembly does not require the intermediate member to operate. However, for best mode of operation and ease of installation of the door lockset, this preferred embodiment of the invention will be described with an intermediate member facilitating the linking and extension of linear movement of the latch bolt assembly 60. The rigid link 50 is able to rotate or swivel in a clockwise and anticlockwise direction about it's two joints 55 depending on whether the sliding shaft 52 is actuated in a pull or push operation at either side. In either rotational direction, the rigid link 50 can achieve a latch tongue retraction. The described alternative shaft assembly 3 allows a door to be opened on one side either by pushing or pulling the door handle (pull or push operation in the direction of ‘B’ in FIGS. 21 and 22, respectively). By contrast, the sliding shaft assembly 2 as previously described, can only be either pushed or pulled from one side of the door (push or pull operation in the direction of arrow A in FIG. 3).

The proceeding paragraphs will now detail the alternative sliding shaft assembly 3, which may also be implemented and adapted as a preferred embodiment in the present invention which comprises: a rigid link 50; a sliding adapter 51; a sliding shaft 52; locking mechanism 245; and lockset roses 53, 54.

As described in brief above, the rigid link 50 includes two pivot pin holes 55 one at each end of the rigid link. Referring to FIG. 19, a pin hole 55 of the said rigid link 50 is fixed to the sliding shaft 52 by means of inserting said link 50 into shaft slit 57. Then with said pin hole 55 co-aligned with pin hole 59, a pivot pin 56 secures rigid link 50 therein. Once the rigid link 50 is fixed to the sliding shaft 52, the rigid link 50 (by means of its pivot pin holes 55) has it's rotational axes disposed perpendicular to the plane of linear movement of the said sliding shaft 52, sliding adapter 51 and latch bolt assembly 60. The other joint or pivot pin hole 55 of the rigid link 50 is connected to the sliding adapter 51 through similar means, with a pivot pin 71 running through the other co-aligned pivot pin hole 55 with pin hole 72 located on the said members respectively. By contrast to the crank mechanism (actuator 16) the rigid link 50 is able to pivot at two points, with one pivot point fixed to longitudinal axis of movement (the latch bolt assembly 60) of the lockset and the other to a fixed to lateral axis of movement (the sliding shaft 52) of the lockset. The rigid link 50, being of finite length, is able to effectively shorten it's longitudinal length relative to the lockset upon transverse movement of the sliding shaft 52, this is due to the rigid link 50 being disposed on an angle relative to the longitudinal axis upon actuation. The said shortened length along the longitudinal axis of the lockset will cause the latch tongue 4 (which also has finite length), to retract the said latch tongue into the faceplate housing 10 (as the latch bolt's length is also aligned with the longitudinal axis of the lockset, see FIGS. 21 and 22).

In this preferred embodiment, the sliding adapter 51 operates as an adaptable extension of the latch bolt assembly 60, by allowing it to link and move linearly with the said latch bolt assembly. The sliding adapter member 51 further comprises a linking spigot 61 (male linking means) which engages into an aligned female socket or aperture, such as the connecting rod's clevis 12 or an eye 62 of an eyebolt as depicted in FIG. 19. The sliding adapter 51 moves linearly in the same direction of the latch tongue 4 when in operation and transverse in direction relative to the sliding shaft 52 by means of a guiding bracket 64, which mounts and provides coupling and sliding means for track channel 63 of the sliding adapter 51, thereon. Furthermore, it could be described that the sliding adapter 51 and rigid link 50 are joined together to form an actuator assembly.

The sliding shaft 52 is essentially the same as the sliding shaft 20 described above, implementing similar spring and lock rod retaining hole 23 and projection 48 features, however in this preferred embodiment; hole or aperture 73 and projection 65 are positioned at the midpoint of the sliding shaft 52 as opposed to being off-centre, compared to the sliding shaft member 20. The sliding shaft 52 comprises an additional interposed spring 66 between the projection 65 and second rose 54 compared to said features on the sliding shaft 20. The additional spring 66 allows the spring biased sliding shaft member 52 to retract back into position upon being pushed or pulled from either end. The lock rod 247 and compression springs 66, 67 are fixed in place similarly to the locking mechanism 45 in sliding shaft assembly 2, described above, by means of aperture 73 and lock rod holes 74, 68 on the lockset roses. The said lock rod 247 is similarly operated as lock rod 47 described above. Except differing in that the locking rod has two latch arms 246 and two correspondingly aligned lock sockets 70 to prevent the shaft from moving in either direction upon the lock rod 247 being pivotally operated into locking position. The insertion of the locking rod 247 into the aperture 73 is such that one of the latch arms 246 is only attached after the insertion of the said rod 247 into the aperture 73. Alternatively, the aperture 73 may comprise a ‘u-groove’ (not shown) which allows mounting the lock rod 247 laterally thereon and not requiring mounting by inserting the said rod therethrough.

The first lockset rose 53, comprises all the same mounting features of the lockset rose 27, except in place of a ledge 28 it comprises a guiding bracket 64 which mounts and guides the sliding adapter 51. The guiding bracket 64 has a mounting edge shaped and sized to achieve coupling of the track channel 63 of the sliding adapter 51, which could either be correspondingly shaped; round, square or any polygonal shape. The sliding shaft 52 is similarly inserted and partially extends through the shaft apertures 75, 69. The sliding adapter 51 is then slidingly mounted into the guiding bracket 64 with it's pivot pin hole 72 fixed to the rigid link 50 by means of; joint 55, pivot pin 71 and holes 72. The said sliding adapter is orientated so that the attached rigid link 50 is directed towards the link slit 57 and the linking spigot 61 directed towards the latch bolt assembly's 60 linking means, eye 62, as illustrated in FIG. 19. The other end of rigid link 50 is then inserted and fixed into the link slot 57 and secured by the pivot pin 56 by means of accommodating hole 59. A compression spring 67 is then mounted between the lockset rose 53 and the shaft projection 65. The spring 66 is then positioned on the other side of the retainer aperture 73; the lock rod 247 is then from the depicted side in FIG. 19, inserted through the said spring 66, then through aperture 73, then through spring 67 and then lock hole 74.

The second lockset rose 54 comprises all the same mounting features as the second lockset rose 36. Once the preassembled sliding shaft assembly 3, as described above, is inserted into the door cavity and mechanically linked to the latch bolt assembly 60, via eye 62 and linking spigot 61, the second lockset rose 54 is mounted onto the other side. Ensuring that the other ends of the sliding shaft 52 and lock rod 247 are inserted and extended through corresponding shaft aperture 69 and lock hole 68, respectively.

The lock lever 292 is then secured at a distal end 289 of the lock rod 247 from the external lockset (at either end). The side on which the said lever is attached depends on the side a locking mechanism is preferred. Operating handles (not shown) can then be finally attached onto the shaft's ends.

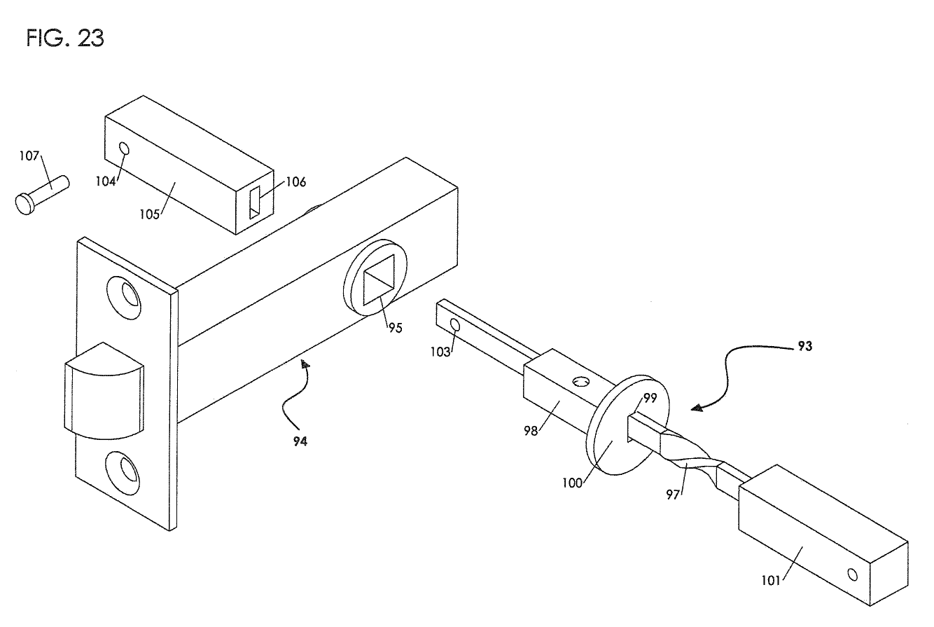

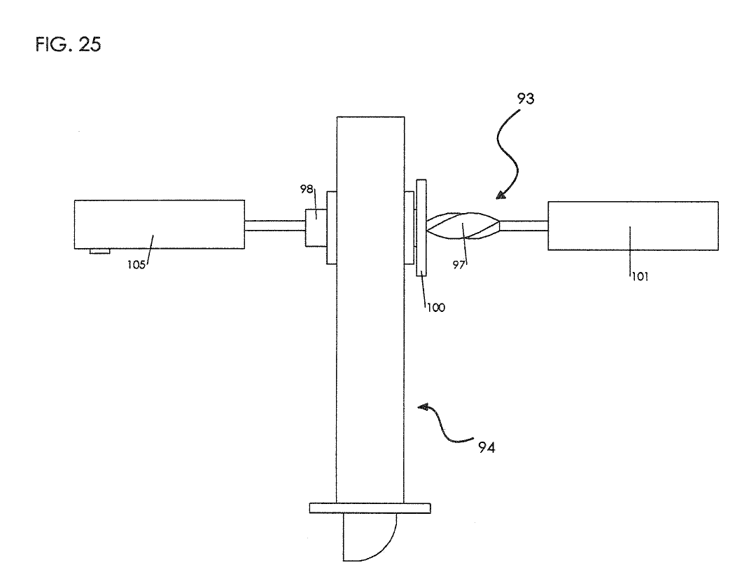

As illustrated in FIGS. 23 to 25, in another preferred embodiment of the present invention comprises a sliding shaft adapter assembly 93, to operably engage with a conventional rotational latch bolt assembly 94 through the conventional shaft or spindle aperture 95, and is operable therein and therethough. The aforesaid sliding shaft adapter assembly 93 translates linear movement of the sliding shaft 101 or handle (not shown) into axial movement within the spindle aperture 95. Extension 105 of the sliding shaft allows the adapter assembly 93 to have a handle mounted and be operable on the other side of the lockset. The sliding shaft adapter assembly 93 is described hereinafter without the lockset roses and locking mechanism. As these omitted members of the lockset are common in all three preferred embodiments of the invention it is unnecessary to repeat describing them.

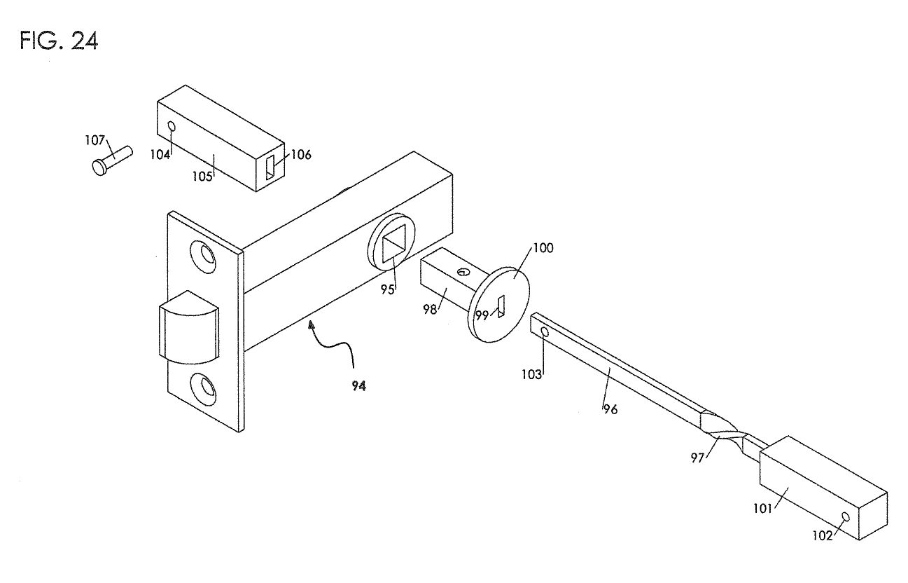

In further detail seen in FIG. 24, the said sliding shaft adapter assembly 93 comprises: a sliding shaft 101 with a distal end resembling a metal key 96 section incorporating an engagement means, or in this preferred embodiment, an integrated twist 97; and a square tube 98 with a narrow key eye 99 and retaining means 100. The said metal key 96 is inserted through the said key eye 99 of the said square tube 98 member. As the metal key 96 is inserted into the eye 99 of the square tube 98, the twist 97 slides through the square tube 98 and therein turning the square tube axially. Provided that the metal key 96 maintains fixed orientation except longitudinally, as the metal key 96 moves into and through the eye 99 of the square tube 98, the integrated twist 97 will cause the square tube 98 to rotate. The square tube 98 comprises a retaining means 100 to keep the square tube from being pushed out of the spindle aperture 95, and to maintain position within the said spindle aperture 95 upon shaft actuation. In this way the sliding shaft adapter assembly 93 achieves conventional rotational actuation by means of a square tube 98. Thus in this preferred embodiment of the present invention, the sliding shaft adaptor assembly 93 and it's actuator, square tube 98, are capable of engaging and operating the conventional latch bolt assembly 94.

Similarly, to the above described sliding shafts 20, 52, the sliding shaft 101 comprises: similar handle mounting holes 102, 103 and 104. The handle mounting hole 103 at the distal end of the metal key 96 is inserted into aperture 106 of the extension 105 and is extended therein inwards until the hole 103 is co-aligned with hole 104 of the extension 105. This allows a small screw bolt 107 to fix the metal key 96 thereon and further, shaft 101 to the other operable side of the lockset, namely extension 105. A handle (not shown) may also be mounted in the same hole 104 and co-aligned hole 103 by means of the same screw bolt 107. It is not shown, however, similar lock sockets 22, 30 as described previously are also adopted on the sliding shaft 101.

Furthermore, the sliding shaft 101 is interposed between the first and second lockset roses (not shown) through similar mounting means to the previously described sliding shafts 20, 52 of the preferred embodiments of the invention.

Although the invention has been described in connection with several preferred embodiments, it should be understood that various modifications, additions and alterations may be made to the invention by one skilled in the art without departing from the spirit and scope of the invention as defined in the appended claims.

1. A push and/or pull handle lockset, which comprises:
a latch tongue in first extended latching position, and is linearly actuated into second retracted unlatched position; a biasing means urging the said latch tongue in the said first extended latched position; a rearward projecting female or male linking means to link but not affix the latch bolt assembly with the actuator or an actuator assembly;
a sliding shaft extending transverse through the main planes or faces of the first and second lockset roses and transverse to the said latch tongue, and is operable linearly back and forth along it's longitudinal axis from first resting position to second operating position therethrough; handle mounting means at both distal ends of the said shaft to mount handles to operate the lockset;
a biasing means to urge the said sliding shaft back to first resting position after operation;
an engagement means to allow the said sliding shaft to engage with an actuator or an actuator assembly;
an actuator or an actuator assembly to translate direction of linear movement of the said sliding shaft to operate the said latch tongue into second retracted unlatched position;
first and second lockset roses with a plurality of mounting means, to mount, adjust, secure and house the assembly members of the lockset unit;
a lockset locking mechanism operable in and out of locking positions to lock the lockset.
A lockset unit operation that is adapted to be reversed by rotating the said lockset unit through one hundred and eighty degrees (180°) about it's horizontal lateral axis, to change the direction of the actuator or handle operation.

2. The push and/or pull handle lockset claimed in claim 1, wherein said first and second lockset roses with a plurality of mounting means comprises: an actuator or an actuator assembly mounting means; shaft apertures permitting one end of the sliding shaft to extend and retract therethrough within limits of operation; a mounting means to mount the sliding shaft biasing and actuator biasing means to retract and urge the sliding shaft and actuator to desired position; a lock mounting means to mount the said locking mechanism and permit it to operate in and out of locking positions thereon or therethrough; and a door bore mounting means to secure and position the lockset unit onto a door.

3. The push and/or pull handle lockset claimed in claim 1, wherein said rearward projecting female or male linking means further comprises a detaching means to temporarily detach or disengage from the remaining lockset assembly, upon the said latch tongue engaging the striker plate on the door frame. Said detaching means providing said latch tongue independent retraction from the remaining lockset assembly, into second position.

4. The push and/or pull handle lockset claimed in claim 1, wherein said engagement means comprises a bored slot integrated into the sliding shaft to engage, mount or affix the said actuator or an actuator assembly therein.

5. The push and/or pull handle lockset claimed in claim 1, wherein said locking mechanism comprises a lock rod which transverses the said lockset roses and it's longitudinal axis disposed parallel with the longitudinal axis of the sliding shaft; the said lock rod's distal ends partially protrude through to the external faces of both said lockset roses via locking mechanism mounting means found on each lockset rose; the said longitudinal axis of the lock rod is fixed therein and therethrough. Rotational operation about the said rod's longitudinal axis on both external sides of each lockset rose is permitted by; a lever, knob, or operating handle which is selectively mountable externally at either distal end of the said rod. Said rotational operation of the lock rod will engage it's locking and unlocking positions.

6. The push and/or pull handle lockset claimed in claim 5, wherein said lock rod further comprises of one or more fixed lateral latch arms or cam members projected from the said lock rod's body, disposed thereon such that they are between the first and second lockset roses. The said latch arms or cams may abut against the internal faces of the said roses precluding the full extension of said lock rod in either direction through the said roses, thus fixing the said lock rod longitudinally therein. Upon operably rotating the lock rod about it's longitudinal axis in either direction, the said latch arms or cams rotatably engage into the aligned locking means on the sliding shaft

7. The push and/or pull handle lockset claimed in claim 6 wherein said locking means on the sliding shaft further comprises one or more receiving locking sockets or mounting recesses in alignment with the said latch arms or cams of the said rod. Such that when the said rod is operably rotated, the said latch arms or cams are also rotated and received and engaged thereinto said locking sockets. The said latch arms or cams therein impede the movement of the said sliding shaft longitudinally as the lock rod is also fixed therein longitudinally by means of said latch arms or cams. Thus, the sliding shaft is also precluded from being extended through the lockset roses. Hence, in this manner the engaged latch arms or cams immobilises the sliding shaft and actuator, effectively locking the lockset.

8. The push and/or pull handle lockset as in any one of the preceding claims, wherein said sliding shaft further comprises: a fixed lateral projection thereon; said projection includes a lock rod and spring mounting means, said means is disposed on the projection in alignment with the lock mounting means of the lockset roses. Said projection with it's lock rod and spring mounting means is interposed between the lockset roses; with said lock rod mounted therein and therethrough. The locking rod therein aligned with the said mounting means allows: ease of lockset rose mounting; the longitudinal axis of said rod to be kept in parallel alignment with the sliding shaft. Furthermore, the said projection also functions as a shoulder abutting the internal faces of the lockset roses when the sliding shaft is in first or second positions to preclude the sliding shaft from retracting or operating beyond operational limits through the said roses.

9. A push and/or pull handle lockset as in any one of the preceding claims, wherein said lock rod further comprises a compression spring which is mounted thereon. Said spring is retained and interposed between the said latch arms or cams of the locking rod and the said lateral projection of the sliding shaft. The said interposed spring therein exerts force upon the said lateral projection to urge the sliding shaft back to first position, whilst also permitting the said locking mechanism to rotate about it's longitudinal axis therein.

10. The push and/or pull handle lockset claimed in claim 2, wherein said actuator mounting means further comprises of a mounting bracket to pivotally mount an actuator onto the said first or second lockset rose.

11. The push and/or pull handle lockset claimed in claim 10 wherein said mounting bracket to mount an actuator further comprises an actuator positioning means to adjust the positioning of the said actuator; to accommodate installation of the lockset unit onto various door thicknesses.

12. The push and/or pull handle lockset claimed in claim 1, wherein said actuator to translate the direction of linear movement of the said sliding shaft to operate the said latch tongue into second retracted unlatched position comprises: a pivoting two armed crank; the first arm (a male linking feature) engages or links with the corresponding rearward projecting female linking means of the said latch bolt assembly; the second arm (male linking feature) of the said crank, links or engages with the corresponding engagement means of the said sliding shaft member; the said crank is pivotally mounted onto a lockset rose's actuator mounting means. Thus, pivotally interposed between the two said lockset assembly members, the said first and second arms simultaneously engages and actuates the said lockset assembly members into their respective second positions upon the said crank rotating about it's fixed pivot point. Thus, the said crank facilitates the change in direction of linear movement of the sliding shaft member to retract the said latch bolt member linearly into second position.

13. The push and/or pull handle lockset claimed in claim 12, wherein said pivoting crank member further comprises a biasing means to urge the said crank to retract and remain in position after operation.

14. The push and/or pull handle lockset claimed in claim 2, wherein said an actuator assembly mounting means further comprises of a mounting bracket to slidingly mount an actuator assembly to engage or link with the latch bolt assembly and the sliding shaft.

15. The push and/or pull handle lockset claimed in claim 1 or 14, wherein said an actuator assembly to translate the direction of linear movement of the sliding shaft to operate the said latch tongue into second retracted position further comprises: a linking member incorporating two pivoting points; and a sliding adapter which is slidingly mounted onto the said actuator assembly mounting means, and which also links with the latch bolt assembly. The said linking member is interposed between the sliding shaft and the said sliding adapter and mounted via it's two said pivoting points to each of the said members. The said linking member therein pivots in either a clockwise or anticlockwise direction upon either a push or pull operation of the said sliding shaft. In either rotational direction, the said linking member will operate the latch bolt assembly, via the linked sliding adapter, into second position.

16. A push and/or pull handle lockset, which comprises:
a conventional latch bolt assembly;
a sliding shaft extending through the spindle aperture of the said conventional latch bolt assembly and lockset roses in a direction transverse of the said latch bolt member, and is operable back and forth linearly and longitudinally therein and therethrough;
a rotatable actuator sized and formed to fit within the conventional latch bolt assembly's spindle aperture, having a retaining means to be retained therein, and having the means to translate the linear movement of the sliding shaft into a pivotal action therein;
first and second lockset rose members to mount, secure and house the assembly members of the lockset;
a lockset locking means to lock the lockset in and out of locking positions.

17. The push and/or pull handle lockset claimed in claim 16, wherein said rotatable actuator having means to translate linear movement of the sliding shaft into a pivotal action comprises of an narrow key hole, slit or eye; disposed in alignment with the spindle aperture and shaped to receive the sliding shaft's key section.

18. The push and/or pull handle lockset claimed in claim 16 or 17, wherein said sliding shaft further comprises an insertable key section with one or more integrated twists. As the distal end of the said key section is inserted into the said narrow key hole of the rotatable actuator, the said integrated twists engages with the narrow key hole and rotates the said actuator axially. Moreover, as the sliding shaft traverses therein in fixed lateral position, the said rotatable actuator will be forced to rotate along the twisted profile of the key section of the sliding shaft. Thus, as the said actuator rotates within the spindle aperture of the said latch bolt assembly, the said manner of rotation therein actuates the latch bolt into retraction.

19. A method of fitting and installing a push and/or pull handle lockset into standardised lockset bored cavities, which comprises:
a latch bolt assembly comprising; a latch tongue in first extended latching position and is operable into second retracted unlatched position; and a rearward linking means;
a sliding shaft assembly comprising; a sliding shaft operable back and forth linearly and longitudinally from first resting position to second operable position along it's longitudinal axis which is disposed transverse to the said latch tongue; and
a linking feature to link with the complementary linking means of the latch bolt assembly;
a second lockset rose with a plurality of mounting means, to mount, adjust, secure and house the assembly members of the lockset unit;
lockset mounting screws to secure the lockset unit via lockset mounting roses onto the door and to enclose the internal lockset mechanisms;
the said method of lockset installation, which comprises steps of;
firstly, mounting and fixing the said latch bolt assembly into the door's side bored cavity, ensuring that the canted side of the latch tongue is facing the striker plate;
secondly, if necessary, the actuator on the sliding shaft assembly is adjusted to the appropriate door thickness configuration by unsecuring the actuator mounting means and moving the actuator to desired position on the said mounting means;
thirdly, if necessary, orientating the sliding shaft assembly along it's horizontal lateral axis to one of two operable directions. The preferred side of the door where the sliding shaft assembly is thereon installed would be on the side where; the push of the sliding shaft or handle to operate the actuator is coincidental with the side of the door where it is opened by pushing the door away from the operator;
fourthly, once orientation of the sliding shaft is configured, the aligned linking arm or feature of the sliding shaft assembly, is inserted into or mated with the aligned aperture or feature of the linking means of the latch bolt assembly;
fifthly, once the sliding shaft assembly is inserted into the preferred side of the door's cavity with it's linking feature aligned therein and linked to the latch bolt assembly's linking means, it is secured in place by the lockset rose's circumferential retaining bosses which are dimensioned to fit within the door's cavity periphery;
sixthly, the second lockset rose is then inserted onto the other side of the door's face, ensuring that the distal ends of sliding shaft member and the locking mechanism are inserted into the second rose's shaft and lock mounting apertures, respectively;
seventhly, the lockset roses are then securely mounted by two mounting screws;
eighthly, a lever or knob is then attached onto an end of the locking mechanism, preferably on the side of the door where an operable lock is desired;
finally, the lockset operating handles are then mounted onto the ends of the sliding shaft for handle operation of the lockset unit;

20. A lockset substantially as herein described with reference to the accompanying drawings.
